(19) United States
(12) Patent Application Publication
(10) Pub. No.: US 2015/0206461 A1
(43) Pub. Date: Jul. 23, 2015

(54) BATTERY CASSETTE AND AN ELECTRONIC SHELF LABEL COMPRISING SAID BATTERY CASSETTE

(71) Applicant: PRICER AB, Stockholm (SE)

(72) Inventor: Jörgen Jubro, Balinge (SE)

(73) Assignee: PRICER AB, Stockholm (SE)

(21) Appl. No.: 14/413,087

(22) PCT Filed: Jun. 28, 2013
(86) PCT No.: PCT/SE2013/050815

§ 371 Date: Jan. 6, 2015

(30) Foreign Application Priority Data
Jul. 6, 2012 (SE) 1250796-8

(51) Int. Cl. G09F 3/20; H01M 2/10

(52) U.S. Cl. CPC G09F 3/208; G09F 3/204; H01M 2/1066; H01M 2220/30

(57) ABSTRACT

A battery cassette for an electronic shelf label including a cavity for the battery cassette. The cassette includes: a casing; a space defined within the casing for at least one battery; and a releasable locking mechanism for securing the battery cassette in the cavity of the electronic shelf label. Also provided is an electronic shelf label including the battery cassette.

### FIELD OF THE INVENTION

The present invention relates to battery cassette and an electronic shelf label comprising said battery cassette.

### BACKGROUND OF THE INVENTION

In different types of stores, for example supermarkets etc, electronic shelf labels, also referred to as ESL, are used for displaying information about the different products offered in the store. The information displayed is for example the name and type of product as well as the price for each of the products.

The electronic shelf labels are communicating with a central control unit that makes it possible to frequently update and change the information displayed on the labels which sames a considerable amount of time for the persons working in the store, especially if the number of different products sold in the store is high. As an example, a supermarket offers between 50000 and 100000 different products.

In order to power the electronic shelf labels, one or more batteries are arranged in each label. However, since each battery stores a limited amount of energy, the labels are either disposed and replaced by a new label when the battery is empty, alternatively the batteries must be regularly replaced. Disposal of the entire electrical shelf label result in a lot of waste material. Unfortunately, replacement of the batteries requires that the replacement batteries are correctly positioned and of the right type to ensure the desired function of the electronic shelf label which makes the work time consuming for the staff, and consequently expensive.

In order to facilitate the replacement of batteries, different types of support arrangement in which the batteries are arranged before they are inserted together with the support arrangement in the shelf label are used today on the market. These arrangements are however complicated for the staff to handle and have proven to not always provide the desired function of the shelf label after the batteries have been replaced.

There is consequently a need for an improved electronic shelf label arrangement that makes it possible to regularly replace the batteries of the labels and ensure the desired function of the label.

### SUMMARY OF THE INVENTION

The present invention, defined in the appended claims, provides a battery cassette that fulfils the needs defined above, and an electronic shelf label comprising the battery cassette.

The claimed batter cassette for an electronic shelf label comprises:
a casing having an outer periphery shaped to fit in said cavity, said casing has a first side that is closing the cavity when the battery cassette is arranged in the cavity and at least a second side arranged within said casing;
a space defined within the casing for at least one battery, said space is at least partly enclosed by said casing;
a releasable locking mechanism for securing the battery cassette in the cavity of the electronic shelf label, wherein said locking mechanism comprises a locking protrusion extending from the second side of the casing, and a locking protrusion securing device, wherein the locking protrusion is movable between a locking position in which the locking protrusion is secured in the position extending outside the outer periphery of the second side of the casing, and a non-locking position.

The claimed battery cassette fulfils the needs defined above since the releasable locking mechanism makes it possible to both secure the battery cassette in the cavity of the shelf label in a reliably way and, when the locking mechanism securing device is released, extract the battery cassette from the cavity of the shelf label without the risk for damaging the electronic shelf label. This is a considerable advantage since continued use of the shelf label is ensured as soon as a replacement battery cassette is inserted in the cavity.

Since the locking mechanism is arranged in the disposable battery cassette and no components that could be damaged are arranged in the shelf label, reuse of the electronic shelf label is ensured for a long time. Furthermore, the replacement of the empty batteries could be done in a very efficient way since the battery cassette is extracted from the cavity of the shelf label and replaced by a new battery cassette comprising new batteries which saves time for each replacement operation.

In one embodiment of the battery cassette, the locking mechanism furthermore comprises an elongated arm section with a first and a second end, said first end is movably fastened in the casing, said arm section extends along the first side of the casing along and said locking protrusion is movable by said arm section between the locking position and the non-locking position. This embodiment is favourable since the elongated arm section is used for controlling the position of the locking protrusion. Furthermore, the elongated arm section could be gripped by the person replacing the battery cassette in order to facilitate the extraction of the cassette from the shelf label.

In one embodiment of the battery cassette, the releasable locking protrusion securing device is arranged in the second end of the elongated arm section. This embodiment is favourable since the securing device both secures the locking protrusion and maintains the elongated arm section in a position extending along the first side of the battery cassette where it closes the opening to the cavity in the shelf label.

In one embodiment of the battery cassette, the releasable locking protrusion securing device comprises securing means for securing the outer end of the elongated arm section to the casing thereby closing the recess in the electronic shelf label.

In one embodiment of the battery cassette, the securing means for securing the outer end of the elongated arm section to the casing is releasable by pressing an activation surface of the securing means, said activation surface is accessible from the first side of the battery cassette. This embodiment facilitates the unsecuring and removal of the battery cassette from the shelf label since the activation surface is accessible from the outside of the shelf label.

In one embodiment of the battery cassette, the battery cassette comprises a first and a second contacting device for connecting the battery poles with the electronic shelf label, said contacting elements extend from the periphery of the casing. This embodiment ensures the desired contact between the battery poles of the batteries in the cassette and the shelf label. Furthermore it is very advantageous to have the connecting devices in the battery cassette since the connecting devices are replaced together with the cassette and the desired contact between the connecting devices of the cassette and the ESL is achieved since there risk for oxide damaging the contact is reduced.

In one embodiment of the battery cassette, the first and second connecting device are extending from the casing and are resiliently supported in the battery cassette. This embodiment increases the chance for the desired contact between the cassette and the ESL since the connecting devices are pressing against the corresponding connecting means of the ESL.

One embodiment of the battery cassette comprises a first and a second recess formed in the casing, said recesses are formed opposite to connecting devices in the opposite side of the casing. This embodiment makes it possible to pack a number of cassettes on top of each other since the connecting devices of one cassette will be arranged in the recesses of the adjacent cassette. The risk for short circuit between adjacent cassettes is thereby eliminated.

In one embodiment of the battery cassette, the casing is formed by a first and a second casing element. This embodiment makes it possible to insert the battery, or batteries, as well as the contacting elements before the two casing elements are secured together to complete the battery cassette.

In one embodiment of the battery cassette, the elongated arm section, after the releasable locking protrusion securing device is released from the locked position, is released from the casing. This embodiment is favourable since the fact that the elongated arm section is removed from the battery cassette makes it impossible to reuse the battery cassette.

In one embodiment of the battery cassette, the battery cassette comprises a memory card in order to provide additional memory capacity to the electronic shelf label. This is very favourable when additional memory is required to upgrade the electronic shelf label to display new or further information since the upgrade could be done at the same time as the battery cassette is changed.

The invention furthermore relates to an electronic shelf label for displaying information comprising:
a label casing comprising a cavity accessible from the outside of the shelf label via a first opening, and a locking recess formed in the cavity;
contacting means arranged in the cavity; and
a battery cassette according to anyone of the embodiments described above, wherein the locking protrusion of the battery cassette is arranged in the locking recess of the label casing when the battery cassette is secured in the shelf label.

In one embodiment of the electronic shelf label, the shelf label casing comprises a second opening to the cavity, and the battery cassette casing comprises a gripping area accessible via the second opening in order to extract the battery cassette from the cavity. This embodiment facilitates the removal of the battery cassette from the cavity since the gripping area could be used to apply a force on the battery cassette in the extraction direction.

In one embodiment of the electronic shelf label, the battery cassette comprises a first and a second contacting element for connecting the battery poles with the connecting means of electronic shelf label.

The different described embodiments of the battery cassette and the electronic shelf label could of course be combined in different ways without departing from the scope of the invention that will be described more in detail in the detailed description.

### BRIEF DESCRIPTION OF THE DRAWINGS

One embodiment of the battery cassette and ESL according to the invention is illustrated in the appended figures.

FIG. 1 illustrates a perspective view of an ESL.

FIG. 2 illustrates an exploded view of the ESL.

FIG. 3 illustrates a exploded view of a battery cassette.

FIG. 4 illustrates an sideview of the battery cassette.

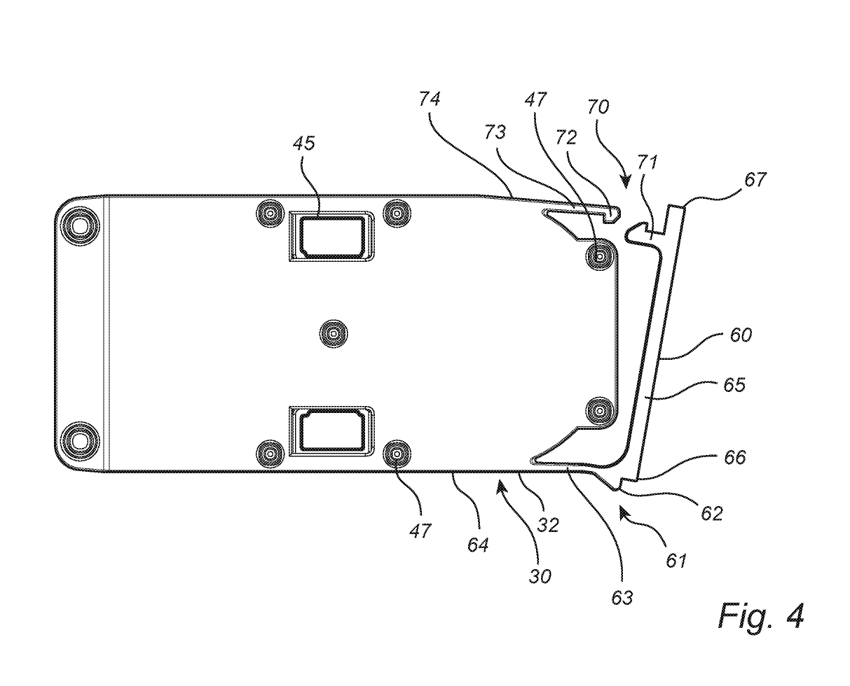

### DETAILED DESCRIPTION OF EMBODIMENTS

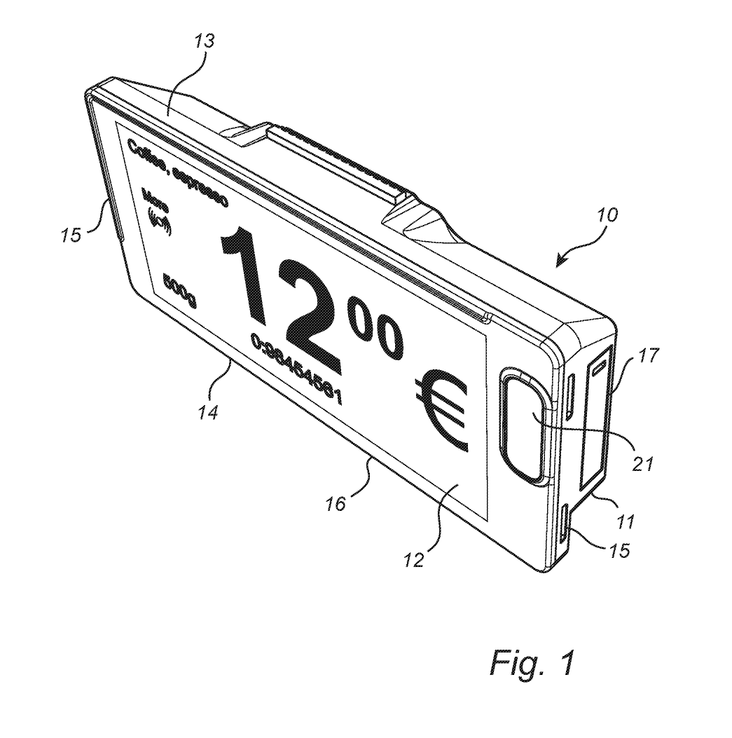

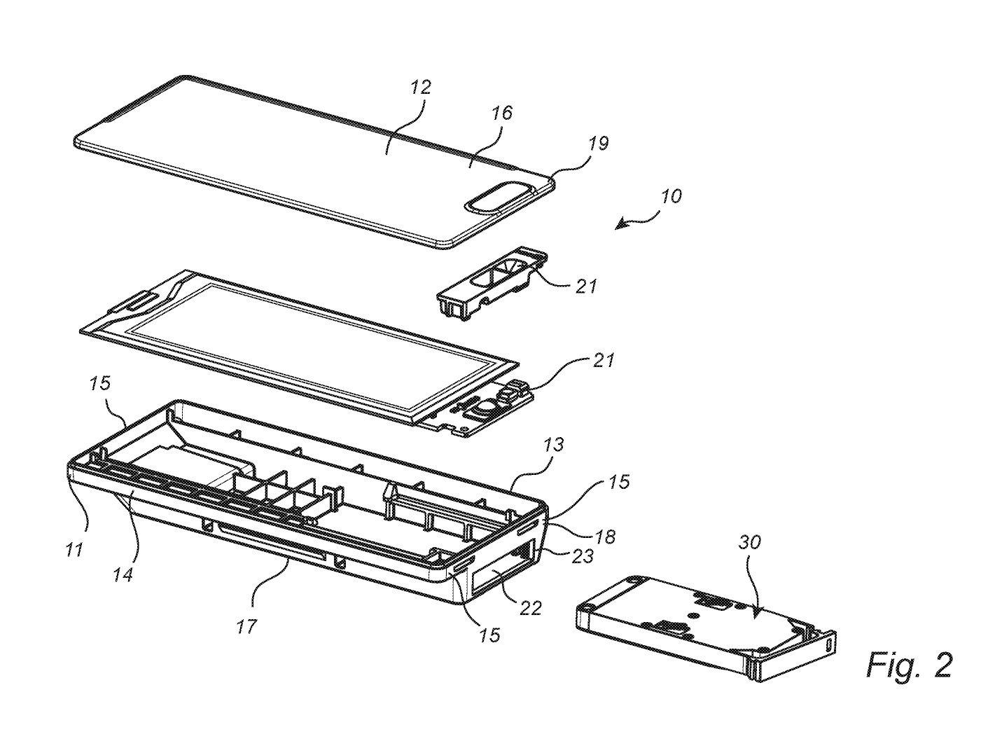

In FIG. 1 a perspective view of an ESL, and in FIG. 2 an exploded view of an electronic shelf label 10, ESL, is illustrated. The ESL 10 comprises a housing 11 and a display area 12. The housing is substantially rectangular with an upper 13 and lower side 14 arranged parallel to each other, two side surfaces 15, and a forward 16 and back 17 side. The forward side is substantially flat and comprises the display area 12. The housing 11 is made of at least a first 18 and a second 19 housing section in order to facilitate the manufacturing of the different sections and the mounting of the different components enclosed by the housing 11. The housing is for example made of a plastic material that provides the desired structural strength as well as the desired appearance of the ESL. The display area 12 is preferably as large as possible to improve the visibility of the ESL during use. The layout on the display is adapted to the specific use of the ESL.

Along the upper and lower side of the ESL, elongated protrusions 20 are extending. The elongated protrusions make it possible to fasten the ESL in a fastening rail arranged along the forward edge of a shelf or desk. The fastening rail, not illustrated in the figures, has a C-shaped cross section and encloses the back side of the ESL when the ESL is fastened in the intended position along the fastening rail. However, other solutions for fastening the ESL to a shelf are already known and could of course be used instead of the described solution.

In the forward side of the ESL, means 21 for communication between the ESL and a central control system is arranged. In the illustrated ESL, this communication involves means for infra red optical communication with an in the store centrally arranged control unit. Other alternatives for communication between the ESL and the central control system are however possible and the means for communication arranged in the ESL are then modified or adapted to the desired system for communication. In a further embodiment of an ESL, the means for communication could be arranged in the side surfaces or integrated within the casing as long as the desired contact between the ESL and the central control unit is achieved.

The ESL furthermore comprises a battery cassette 30 arranged in a cavity 22 in one of the side surfaces of the casing. The cavity is arranged within the housing 11 and extends from a first opening 23 in one of the side surfaces of the housing into the ESL. The size and shape of the cavity 22 corresponds to the size and shape of the battery cassette 30 that will be described in detail further down this document.

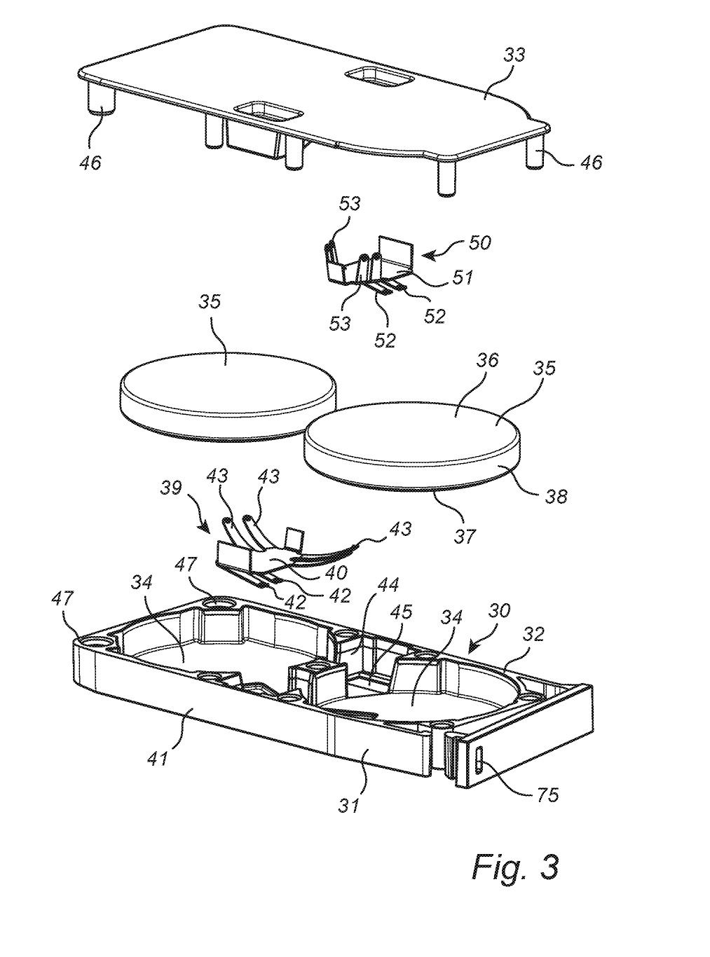

In FIG. 3, an exploded perspective view of the battery cassette 30 is illustrated. The cassette 30 has a substantially cuboidal peripheral shape adapted to the available space within the ESL, and the dimensions of the batteries 35 fitted in the cassette 30. The battery cassette casing 31 is formed by a first 32 and a second 33 casing section. In the first casing section 32, a space 34 for each of the batteries 35 is formed in order to provide support for the batteries enclosed by the casing 31. In the illustrated embodiment, the cassette 30 is designed for housing two round batteries with a limited height. Each battery 30 has a circular upper side 36, a circular lower side 37 and a peripheral surface 38 extending around the battery. The batteries are preferably batteries of standard type, such as for example CR2032. The number of batteries, as well as the size of the batteries could however be changed in order to adapt the battery capacity and/or size of the battery cassette to the characteristics of a particular ESL. In order to facilitate the introduction of the battery cassette 30 in the recess 22 of the ESL the forward end of the battery cassette is slightly narrower than the rest of the cassette.

The batteries are arranged separated from each other side by side within the casing in respective space 34 defined within the first casing section 32. Close to the centre of the battery cassette, between the two batteries, a first 39 and a second 50 connecting device for connecting the two batteries with corresponding connecting means in the cavity 22 of the ESL 10 are arranged.

The first connecting device 39 has a device body 40 arranged in a recess 41 formed in the first casing section in order to be held in the intended position between the two batteries. From the device body 40 two connection extensions 42 extend through a first passage in the first casing section 32 to meet the corresponding connecting means in the ESL. The connection extensions 42 extend in a direction from the device body 40 such that an angle is formed between the outer surface of the battery cassette and the connection extensions 42. The angle is preferably with the range of 15° to 85° in order to ensure contact between the connecting extension and the connecting means of the ESL. Furthermore the angle result in resilient connecting extensions which further improves the accuracy of the contact between the battery cassette and the ESL. The outer end connecting extensions has a curved shape so that a ridge is formed before the outer end is extending towards the battery cassette. This is favourable since the ridges are intended to align the contacting means of the ESL while the inwardly curved outer ends of the connecting extensions ensures that connecting extension not will grip the edge of the opening 23 during extraction of the battery cassette from the cavity 22.

Furthermore two protrusions 43 extend from the device body towards each of the batteries. The protrusions 43 are slightly curved upwards to press against the lower circular side 37 of the batteries 35 when the components of the battery cassette are correctly mounted within the cassette, and thereby ensure the desired alignment towards the battery.

The second connecting device 50 is arranged separated from the first connecting device 39 to avoid contact between the first and second connecting device. The second connecting device comprises a device body 51 arranged in a recess 44 formed in the first casing section in the same way as the first connecting device. From the device body 51 a connection extension 52 extend through a second passage 45 in the lower side of the first casing section 32 to meet the corresponding connecting means in the ESL. The connection extension 52 of the second connecting device has a similar design and function as the one of the first connecting device described above. The second connecting device 50 however comprises two arms 53 extending from the device body towards each of the outer peripheral sides 38 of the batteries 35. The arms 53 are extending in a direction upwards from the device body such that they are pressed against the peripheral side 38 of the batteries when correctly mounted within the cassette 30.

The batteries 35 and the first 39 and second 50 connecting devices are held in place within the cassette 30 by the second casing section 33 that is press fitted to the first casing section 32. At the same time as the second casing section is arranged on top of the first casing section, the batteries and the first and second connecting devices are pressed into their correct positions within the cassette. The second casing section is substantially flat and comprises a number of guiding and fastening members 46 that are fitted in corresponding recesses 47 in the first casing section in order to facilitate the positioning of the second casing section to the first casing section, and permanently fasten the first and second casing section together when the guiding and fastening members are pressed into the corresponding recesses in the first casing section. The guiding and fastening members are arranged close to the peripheral sides of the cassette 30 not to interfere with the batteries that requires a considerable amount of the space within the cassette.

The battery cassette 30 is designed to fit in the cavity 22 in the ESL, and when the cassette is correctly fitted in the ESL via the opening in the ESL housing a first side 60 of the cassette closes the opening in the ESL housing.

Due to the limited capacity of the batteries, the battery cassette must be regularly replaced and in order to facilitate both the fitting and the replacement of the battery cassette 30 a releasable locking mechanism 61 is arranged in the cassette casing 31 adjacent to the first side 60 of the cassette.

The releasable locking mechanism 61 is configured to cooperate with a locking recess arranged in the cavity 22 of the ESL 10 and comprises a locking protrusion 62 extending from a second side 64 of the first casing section 32. The locking protrusion 62 is shaped like a knob protruding from a first elastic member 63 formed in the first casing section 32. The elastic member 63 is forming a part of the second side 64 of the first casing section 32 and extend along the periphery of the casing to the corner adjacent to the first side 60 of the cassette 30. At the corner, an elongated arm section 65 extend substantially transverse from the outer end of the elastic member 63. The arm section 65 has a first end 66 and a second end 67, and said first end 66 is connected with the elastic member 63 such that it is movably fastened in the casing 31. The arm section 65 extends along the first side 60 of the cassette casing 31 and the second end 67 of the arm section 65 is forming the corner in the second end 67 of the first side 60 of the cassette 30. Since the locking protrusion 62 is arranged on the elastic member 63 structurally connected with the elongated arm 65, the locking protrusion 62 is movable by the elongated arm section 65 from a locking position in which the locking protrusion is extending outside the periphery of the second side 64 of the cassette casing 31 to an extracted position in which the protrusion 62 is not extending outside the periphery of the cassette casing 31.

The battery cassette furthermore comprises a locking protrusion securing device 70 that makes it possible to secure the cassette 30 in the ESL 10 until the next replacement occasion for the cassette 30. The securing of the locking protrusion 62 is achieved by securing the second end 67 of the elongated arm 65 in the position where the elongated arm 65 is extending along the first side 60 of the cassette and the opening in the ESL housing is closed.

The securing device 70 comprises a fastening hook 71 arranged on the elongated arm section 65 and a fastening flange 72 arranged on the first cassette casing section 32. The fastening hook 71 is arranged in the second end 67 of the arm section 65 on the side of the arm section that is facing the battery cassette 30. The fastening hook 71 is configured to cooperate with the fastening flange 72 that is arranged on a second elastic member 73 formed in the first casing section on the opposite side as the first elastic member 63.

The second elastic member 73 is forming a part of the side 74 of the first casing section 32 opposite to the second side 64 and extend to the corner adjacent to the second end 67 of the elongated arm section 65. The length of the fastening hook 71 is adapted to the position of the fastening flange 72 such that the fastening hook 71 is gripping the fastening flange 72 once the elongated arm 65 is pressed into the locking position where the elongated arm 65 closes the opening in the ESL housing 11. Since the cassette has a substantial cuboidal shape, the first and second elastic member are substantially parallel.

The locking protrusion securing device is releasable by a releasing tool. The releasing of the securing device is achieved by introducing an insert head of the release tool through a release passage 75 in the elongated arm section 65. The insert head is directed towards the fastening flange 72 and the second elastic member 73 and by applying a force on the second elastic member 73 in the direction opposite to the fastening hook 71 the fastening hook 71 is released from the fastening flange 72. As soon as the fastening hook 71 is released from the fastening flange 72 the elongated arm section 65 is extraced from the closed position. After the elongated arm section 65 has been released, the locking protrusion 62 could be removed from the locking position by the elongated arm 65 and the cassette 30 released from the ESL 10.

The elongated arm 65 could also be used for extraction of the battery cassette 30 from the cavity 22 in the ESL which is very favourable since the extraction of previously used battery cassettes were complicated and often resulted in damages on the ESL.

Preferably the elongated arm, after the battery cassette is extracted from the cavity, is released from the cassette casing to ensure that the already used cassette is disposed and replaced by a new cassette.

The release tool could be embodied in many different way as long as it comprises an elongated insert head that is small enough to be introduced through the release passage in the elongated arm and extend to the second elastic member of the first casing section.

In order to further improve the battery cassette and the ESL, an additional memory could be arranged in the battery cassette. The additional memory is connected to the printed circuit board of the ESL via connection means arranged on the battery cassette and within the cavity of the ESL to increase the total memory capacity of the ESL. The increased memory could be necessary to be able to display more, alternatively more complex, information on the display.

The different embodiments described above could all be combined and modified in different ways without departing from the scope of the invention that is defined by the appended claims.

1. Battery cassette for an electronic shelf label comprising a cavity for the battery cassette, said cassette comprising:
a casing having an outer periphery shaped to fit in said cavity, said casing has a first side that is closing the cavity when the battery cassette is arranged in the cavity, and at least a second side arranged within said casing;
a space defined within the casing for at least one battery, said space is at least partly enclosed by said casing;
a releasable locking mechanism for securing the battery cassette in the cavity of the electronic shelf label, wherein said locking mechanism comprises a locking protrusion extending from the second side of the casing, and a locking protrusion securing device, wherein the locking protrusion is movable between a locking position in which the locking protrusion is secured in the position extending outside the outer periphery of the second side of the casing, and a non-locking position.

2. Battery cassette as defined in claim 1, wherein the locking mechanism furthermore comprises an elongated arm section with a first and a second end, said first end is movably fastened in the casing, said arm section extends along the first side of the casing and said locking protrusion is movable by said arm section between the locking position and the non-locking position.

3. Battery cassette as defined in claim 2, wherein the releasable locking protrusion securing device is arranged in the second end of the elongated arm section.

4. Battery cassette as defined in claim 3, wherein the releasable locking protrusion securing device comprises securing means for securing the second end of the elongated arm section to the casing thereby closing the recess in the electronic shelf label.

5. Battery cassette as defined in claim 4, wherein the securing means for securing the second end of the elongated arm section to the casing are releasable by pressing an activation surface of the fastening flange of the securing means, said activation surface is accessible from the first side of the battery cassette.

6. Battery cassette as defined in any one of the preceding claims, wherein battery cassette comprises a first and a section connecting device for connecting the battery poles with the electronic shelf label.

7. Battery cassette as defined in claim 6, wherein the first and second connecting device are extending from the casing and are resiliently supported in the battery cassette.

8. Battery cassette as defined in claim 6, wherein a first and a second recess is formed in the casing, said recesses are formed on the opposite side of the casing as the first and second connecting device.

9. Battery cassette as defined in claim 1, wherein the casing is formed by a first and a second casing element.

10. Battery cassette as defined in claim 1, wherein the elongated arm section, after the releasable locking protrusion securing device is released from the locked position, is released from the casing.

11. Battery cassette as defined in claim 1, wherein the battery cassette comprises a memory card.

12. Electronic shelf label for displaying information comprising:
a label casing comprising a cavity accessible from the outside of the shelf label via a first opening, and a locking recess formed in the cavity;
contacting means arranged in the cavity; and
a battery cassette comprising a casing with an outer periphery shaped to fit in said cavity, said casing has a first side that is closing the opening in the cavity when the battery cassette is arranged in the cavity and at least a second side arranged within said casing; a space defined within the casing for at least one battery, said space is at least partly enclosed by said casing; a releasable locking mechanism for securing the battery cassette in the cavity of the electronic shelf label, wherein said locking mechanism comprises a locking protrusion extending from the second side of the casing, and a locking protrusion securing device, wherein the locking protrusion is movable between a locking position in which the locking protrusion is secured in the position extending outside the outer periphery of the second side of the casing, and a non-locking position, wherein the locking protrusion is arranged in the locking recess when the battery cassette is secured in the shelf label.

13. Electronic shelf label as defined in claim 12, wherein the shelf label casing comprises a second opening to the cavity, and the battery cassette casing comprises a gripping area accessible via the second opening in order to facilitate the extraction the battery cassette from the cavity.

14. Electronic shelf label as defined in claim 12, wherein the locking mechanism furthermore comprises an elongated arm section (65) with a first and a second end, said first end is movably fastened in the battery cassette casing, said arm section extends along the first side of the casing and said locking protrusion is movable by said arm section between the locking position and the non-locking position.

15. Electronic shelf label as defined in claim 14, wherein the releasable locking protrusion securing device is arranged in the second end of the elongated arm section.

16. Electronic shelf label as defined in claim 15, wherein the releasable locking protrusion securing device comprises securing means for securing the second end of the elongated arm section to the battery cassette casing thereby closing the first opening of the cavity in the electronic shelf label.

17. Electronic shelf label as defined in claim 12, wherein battery cassette comprises a first and a second contacting device for connecting the battery poles with the connecting means of electronic shelf label.

18. Electronic shelf label as defined in claim 14, wherein the elongated arm section, after the locking protrusion securing device is released from the locked position, is separated from the casing.
